(19) United States
(12) Patent Application Publication
(10) Pub. No.: US 2009/0315751 A1
(43) Pub. Date: Dec. 24, 2009

(54) ADAPTIVE VEHICLE SYSTEM FOR CONTROLLING A RADIO FREQUENCY (RF) RECEIVER/CONTROL UNIT(S)

(75) Inventors: Brian Bennie, Sterling Heights, MI (US); John Robert Van Wiemeersch, Novi, MI (US); Steven Yellin Schondorf, Dearborn, MI (US); John Tenbusch, Morrow, OH (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, INC., Dearborn, MI (US)

(21) Appl. No.: 12/143,095

(22) Filed: Jun. 20, 2008

(51) Int. Cl. H04L 17/02

(52) U.S. Cl. 341/176; 340/425.5; 340/5.7

(57) ABSTRACT

A vehicle system for controlling at least one radio frequency (RF) receiver/control unit is provided. The system comprises a global positioning system (GPS) receiver, a vehicle controller, and a vehicle interface display. The GPS receiver is configured to generate a geographic location signal indicative of the first location of the RF receiver/control unit. The vehicle controller is configured to associate the geographic location signal to an RF control signal. The vehicle interface display is configured to present at least one menu option for occupant selection to control the operation of the RF receiver/control unit such that the vehicle interface display controls the vehicle controller to transmit the RF control signal to control the RF receiver/control unit to perform the predetermined operation in response to the occupant selecting the at least one menu option.

### BACKGROUND

1. Technical Field

The embodiments of the present invention generally relate to an adaptive vehicle system for controlling at least one radio frequency (RF) receiver/control unit.

2. Background Art

In most cases, automakers generally provide a garage door opener (GDO) transceiver to control a GDO control unit to open/close one or more garage doors. For example, the GDO transceiver is generally packaged within a sun visor located above the driver. The GDO transceiver is configured to receive RF signals from an original GDO transmitter that is provided with the GDO unit. The GDO transceiver receives the RF signals from the original GDO transmitter for configuration purposes such that the GDO transceiver is capable of transmitting the appropriate RF signal to the GDO control unit to perform the predetermined operation. After configuring the GDO transceiver, it is no longer necessary to keep the original GDO transmitter in the vehicle as the GDO transceiver is now trained to transmit the appropriate RF signal to the GDO control unit. While GDO control from a vehicle is generally suitable, automakers recognize the need to integrate more functionality from within the vehicle to control RF-based controls positioned exterior to the vehicle.

### SUMMARY

In at least one embodiment, a vehicle system for controlling at least one radio frequency (RF) receiver/control unit that is positioned exterior to a vehicle at a first location to perform a predetermined operation is provided. The system comprises a global positioning system (GPS) receiver, a vehicle controller, and a vehicle interface display. The GPS receiver is configured to generate a geographic location signal indicative of the first location of the at least one RF receiver/control unit. The vehicle controller is configured to associate the geographic location signal to an RF control signal. The vehicle interface display is configured to present at least one menu option for occupant selection to control the operation of the at least one RF receiver/control unit such that the vehicle interface display controls the vehicle controller to transmit the RF control signal to the at least one RF receiver/control unit to perform the predetermined operation in response to the occupant selecting the at least one menu option.

### BRIEF DESCRIPTION OF THE DRAWINGS

FIG. 1 depicts a vehicle system in accordance to one embodiment of the present invention;

FIG. 2 depicts a lookup table that is stored in a vehicle controller/receiver; and

FIG. 3 depicts a vehicle system in accordance to another embodiment of the present invention.

### DETAILED DESCRIPTION

The embodiments of the present invention generally provide for and not limited to a global positioning system (GPS) receiver that is configured to detect the location of the vehicle such that a vehicle interface display is configured to automatically pull up menu options for allowing a vehicle occupant to select one or more of the menu options to control various control units via radio frequency signals that are positioned at a particular location exterior to the vehicle. The menu options presented to the vehicle occupant for selection are based on the location of vehicle with respect to the control unit(s) as detected by the GPS receiver.

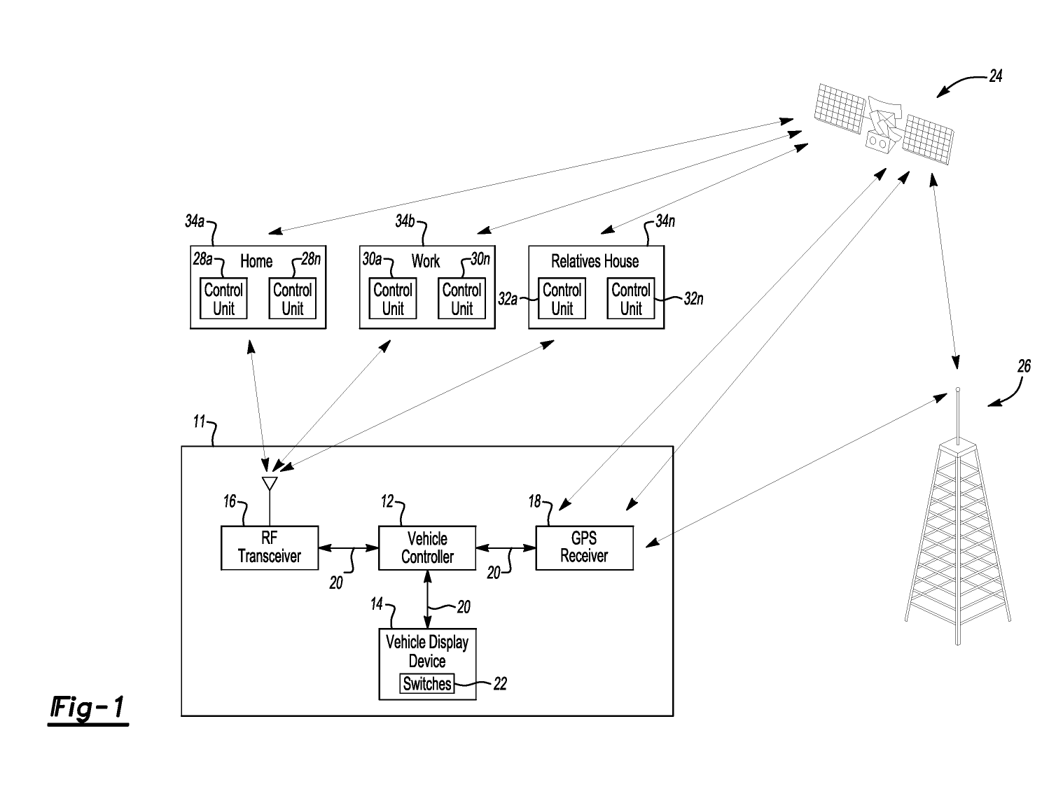

The embodiments of the present invention as set forth in FIGS. 1-3 generally illustrate and describe a plurality of controllers (or modules), or other such electrically based components. All references to the various controllers and electrically based components and the functionality provided for each, are not intended to be limited to encompassing only what is illustrated and described herein. While particular labels may be assigned to the various controllers and/or electrical components disclosed, such labels are not intended to limit the scope of operation for the controllers and/or the electrical components. The controllers (or modules) may be combined with each other and/or separated in any manner based on the particular type of electrical architecture that is desired or intended to be implemented in the vehicle.

Referring now to FIG. 1, a vehicle system 10 for controlling various control units positioned external to a vehicle 11 via RF-based signals are shown. The system 10 includes a vehicle controller 12, a vehicle interface display 14, a radio frequency (RF) transceiver 16, and a GPS receiver 18. A multiplexed communication bus 20 operably couples the vehicle controller 12, the vehicle interface display 14, the transceiver 16 and the GPS receiver 18 together to facilitate bi-directional data communication therebetween. The communication bus 20 may be implemented as a High/Medium Speed Controller Area Network (CAN) bus, a Local Interconnect Network (LIN), or any such suitable data link communication bus generally situated to facilitate data transfer between the controllers (or modules) in the vehicle.

The vehicle interface display 14 may be any such device that is generally situated to provide information and receive feedback to/from a vehicle occupant. For example, the vehicle interface display 14 may be implemented as a message center on an instrument cluster, a touch screen, an audible signal generator or as any such device that is capable of presenting text, displays, status or other such data to the driver. A driver may scroll through the various fields of text and select menu options via at least one switch 22 positioned on or about the vehicle interface display 14. The switch 22 may also be implemented as fixed switches and positioned on the sun visor, overhead console, steering wheel, and/or center stack. The switch 22 may also be implemented in the form of an auditory interface that is configured to receive audible commands from a vehicle occupant. For example, the vehicle interface display 14 may incorporate a software speech recognition module that converts speech to text as disclosed in U.S. Patent Publication No. 20040143440, entitled “Vehicle Speech Recognition System”, filed Dec. 31, 2003 which is hereby incorporated by reference in its entirety. The switches 22 may also be implemented as fields for presentation to a user via a graphic user interface (GUI) whereby such fields are selectable in a touch screen format. The switches 22 may also include other such external device (e.g., phone, computer, etc.) that are generally configured to communicate with the electrical system of the vehicle.

The GPS receiver 18 may optionally include a navigation system for directing a vehicle occupant to a desired location. In response to spoken or selected entries input by the user, the navigation system may transmit directions to the user in an audible or visual format through the vehicle interface display 14 and/or via the navigation system itself.

A plurality of satellites 24 and/or a plurality of ground stations 26 communicate with the GPS receiver 18 to establish the location of the vehicle 11. For example, the GPS receiver 18 is capable of establishing the vehicle's position and velocity relative to the earth's surface by processing data received by the plurality of satellites 24 and/or the ground stations 26. As the vehicle moves latitudinally and/or longitudinally across the earth's surface, the GPS receiver 18 is capable of presenting the position of the vehicle with reference coordinates which correspond to, among other things, the latitude and longitude on the earth's surface. It is generally known that the implementation of a GPS receiver 18 on a vehicle is capable of providing the position of the vehicle relative to the earth's surface.

The transceiver 16 is generally configured to transmit radio frequency (RF) signals to control any one or more control units 28a-28n, 30a-30n, and 32a-32n to perform a predetermined operation at any place 34. Any one or more of the control units 28a-28n, 30a-30n, and 32a-32n may be located at a home 34a of the vehicle driver (or other occupant), a vehicle driver's place of work 34b, and/or a home 34n of a relative of the vehicle driver. In general, the control units may be located at any such location or place that is foreseeable in which the driver would typically drive to and have access to for controlling various control units 28a-28n, 30a-30n, and 32a-32n.

The control units 28a-28n, 30a-30n, and 32a-32n may be configured, but not limited to, open/close garage doors (both large and small), turn on/off one or more lights in a house (or other place), turn on/off one or more television sets, open/close gates of a home (or other place), activate/deactivate home alarm systems, activate/deactivate all vehicle locking/unlocking systems for vehicles at a particular place 34 and/or turn on/off various coffee makers. In the event the predetermined operation includes activating/deactivating all vehicle locking/unlocking systems for vehicles at a particular place 34, an off-board remote keyless receiver on such vehicles could receive the RF signal from the RF transceiver 16 based on the geographic location. The RF signal in this case may include a global arm or global to arm and lock all programmed vehicles that are expected to be at the specific geographic location (or place 34). Such a characteristic may allow a home owner with multiple cars to lock and/or arm the car(s) when leaving a specific geographic location. In addition, a small business owner may globally lock all fleet/pool cars when leaving the site. Generally, the transceiver 16 may be configured to generate any such RF signal used by any one or more of the control units 28a-28n, 30a-30n, and 32a-32n to control any foreseeable operation at any place 34 (or location).

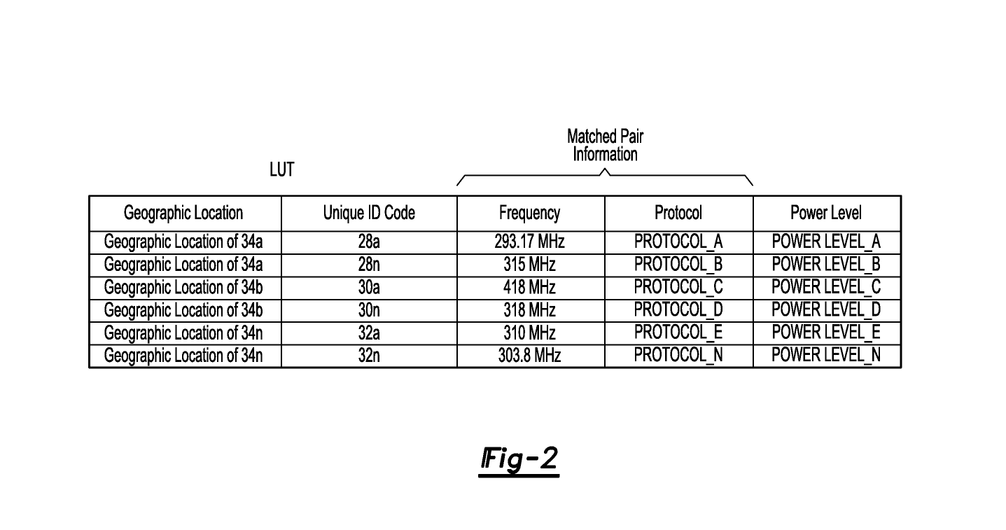

The vehicle controller 12 is generally configured to store the corresponding RF signal, protocol and unique ID for each control unit 28a-28n, 30a-30n, and 32a-32n at each place 34 in a lookup table (LUT) as shown in FIG. 2. The vehicle controller 12 is also configured to store the corresponding power level so that the transceiver 16 transmits the RF signal at a particular power level. As illustrated in FIG. 2, the LUT includes the following columns: geographic location, unique ID code, and matched pair information (e.g., frequency and protocol). In general, the geographic location may correspond to the longitude and latitude of the place 34 (e.g., the home 34a, the work place 34b, or the place 34n of the driver's relative) or to a street number or address of the place 34. The geographic location may also correspond to the elevation of a particular place 34. For example, a multi-level storage garage facility may be positioned at a particular geographic location. In such an example, the elevation of the control unit at the top level may be controlled based on the elevation information. It is generally contemplated that any such location identification may be used in the LUT to represent the geographic location of the place 34. The unique code is generally assigned to each control unit 28a-28n, 30a-30n, and 32a-32n by the vehicle controller 12 during factory transmitter programming. Factory transmitter programming will be discussed in more detail below. The frequency and protocol columns in the LUT include the corresponding frequency (e.g., 293.17 MHZ) and protocol for each control unit 28a-28n, 30a-30n, and 32a-32n as established during factory transmitter programming. The protocols may include Linear, Maranatec, Skylink, Allstar, Fujitsu Ten Ltd., or other known protocols known in the art. The power level generally corresponds to an amount of voltage over distance (e.g., uV/m) at which the particular frequency is transmitted from the transceiver 16 to a receiver in particular control unit. The data in the geographic location, unique ID code, the matched pair, and power level columns may be represented as hexadecimal values (or any other base form generally designated to represent a set of characters in electronic form).

In general, the vehicle interface display 14 is configured to present menu options (e.g., visually or audibly) to the vehicle occupant to allow the vehicle occupant to selectively control any one or more of the control units 28a-28n, 30a-30n, and 32a-32n at any one of the places 34a-34n based on the particular place 34a-34n detected by the GPS receiver 18.

For example, in the event the driver of the vehicle 11 approaches the driver's home 34a, the GPS receiver 18 transmits a geographic location signal (or location message) over the bus 20 to the vehicle controller 12. In response to the vehicle controller 12 receiving the geographic location signal, the vehicle controller 12 queries the LUT and determines that the geographic location signal corresponds to multiple entries under the geographic column (e.g., see FIG. 2 both entries under geographic location column titled “Geographic Location Of 34a”). In such a case, the vehicle controller 12 transmits a signal to the vehicle interface display 14 over the bus 20 so that the vehicle interface display 14 generates and/or presents at least one menu option to allow the occupant to control any one or more of the control units 28a-28n. In one example, the menu options may be in the form of a visual representation of remote controllers on the display 14 that are labeled to indicate which control unit 28a-28n is to be controlled. In another example, the menu option may be in the form of audio or text prompts. In yet another example, the occupant may load custom graphics or other such icons to correspond to a particular control unit 28a-28n.

For example, in the event the driver has a three car garage with one side of the garage having a two car garage door and the other side having a one car garage door and the control unit 28a controls the opening/closing of the two car garage door and the control unit 28n controls the opening/closing of the one car garage door, the vehicle interface display 14 may present either text or audio, a simulated graphic of the remote controller, or pre-loaded graphics for each control unit 28a-28n to allow the driver to select which control unit 28a-28n the driver would like to control. The driver may toggle the switch 22 (via buttons exterior to the screen, touch screen buttons, or voice commands as described above) to select the control unit 28a-28n to perform the operation of opening and/or closing the garage door(s). In response to the driver selecting the appropriate switch 22, the vehicle interface display 14 transmits a selection signal over the bus 20 which is indicative of the desired control unit (e.g., 28a and/or 28n) that is to be controlled to the vehicle controller 12. The vehicle controller 12 receives the selection signal and queries the LUT to determine which frequency, protocol, unique ID code, and power level is needed based on the selected control unit 28a and/or 28n.

In the event the vehicle controller 12 receives the selection signal and determines that the occupant selects control unit 28a via the vehicle interface display 14, the vehicle controller 12 determines that a frequency of 293.17 MHZ and PROTOCOL_A is needed to control the control unit 28a. The vehicle controller 12 transmits an RF control signal to the transceiver 16 via the bus 20. The RF control signal generally corresponds to the frequency (e.g., 293.17 MHZ), PROTOCOL_A, unique ID that is desired to be controlled (e.g., 28a in this case) and the power level (e.g., POWER LEVEL_A). The transceiver 16 transmits an RF signal at a frequency of 293.17 MHZ, at PROTOCOL_A, and at POWER LEVEL_A to the control unit 28a such that the control unit 28a controls the two car garage door to open or close.

In the event the vehicle controller 12 receives the selection signal and determines that the occupant selects control unit 28n via the vehicle interface display 14, the vehicle controller 12 determines that a frequency of 315 MHZ and PROTOCOL_B is needed to control the control unit 28n. The vehicle controller 12 transmits the RF control signal to the transceiver 16 via the bus 20. The RF control signal in this case may include the corresponding frequency (e.g., 315 MHZ), PROTOCOL_B, unique ID that is desired to be controlled (e.g., 28n in this case), and power level (e.g., POWER LEVEL_B). The transceiver 16 transmits an RF signal at a frequency of 315 MHZ, at PROTOCOL_B and at POWER LEVEL_B to the control unit 28n such that the control unit 28n controls the one car garage door to open or close.

The above process may be repeated in response to the GPS receiver 18 detecting that the driver (or vehicle) is located at the driver's place of work 34b or relative's home 34n. As exhibited with the above process, the vehicle interface display 14 may present the driver with the capability of controlling a plurality of control units 28a-28n, 30a-30n, and 32a-32n based on the detected geographic location detected by the GPS receiver 18.

Prior to transmitting the RF signals with the transceiver 16 and the GPS receiver 18 providing the geographic location for the purpose of allowing the vehicle interface display 14 to display the corresponding menus for controlling the appropriate control unit 28a-28n, 30a-30n, and 32a-32n, the vehicle driver may need to configure (or train) the transceiver 16 such that the transceiver 16 transmits the desired RF signal and protocol needed to communicate to any one or more of the control units 28a-28n, 30a-30n, and 32a-32n. As noted above, each control unit 28a-28n, 30a-30n, and 32a-32n may come with a factory transmitter (not shown). In one example, a garage door transmitter may be sold or purchased with a garage door opener control unit.

To program the factory transmitter to the vehicle 11, a user has to perform predetermined operations to learn the factory transmitter to the vehicle 11. Such predetermined operations generally include (i) pressing or holding various buttons (or switches) (not shown) on the transceiver 16 to enter into a learn mode; (ii) positioning the factory transmitter in close proximity to the transceiver 16; and (iii) simultaneously pressing and holding both buttons on the transceiver 16 and on the factory transmitter until a light indicator (not shown) on the transceiver 16 changes status. The above operations are generally used in connection with Homelink® system as provided by Johnson Control Inc. (JCI) which is known to those skilled in the art. Other such methods of programming the factory transmitter to the vehicle may be performed in connection with Car2U™ as provided by Lear which is also known to those skilled in the art.

The vehicle interface display 14 may provide a confirmation message to the user after the transceiver 16 has successfully learned the corresponding RF signals and protocol. The transceiver 16 learns the corresponding RF signal and protocol and transmits such data to the vehicle controller 12 over the bus 20 for storage in the LUT. Prior to storing the corresponding RF signal and protocol in the LUT, the vehicle controller 12 can create the unique ID code and assign the corresponding RF signal and protocol to the unique ID code and store such information in the LUT. After the vehicle controller 12 stores the corresponding RF signal, protocol, and unique ID code; the vehicle controller 12 may transmit a configure command to the vehicle interface display 14 such that the vehicle interface display 14 presents screens or menus which allow a user to program a particular geographic location to the corresponding RF data and protocol information that was saved or learned to the vehicle. The geographic location inputted by the user is an address or other location identifier that is the place 34a-34n in which the corresponding control unit 28a-28n, 30a-30n, and 32a-32n is RF matched to the factory transmitter. The geographic location is saved to the LUT (either as an address or with various coordinates (e.g., latitude and longitude)) and is associated with the particular frequency, protocol, and the unique ID code.

Other embodiments may also include providing software in the vehicle interface display 14, the vehicle controller 12, and the GPS receiver 18 to notify the driver via the vehicle interface display 14 that no such activation of the control unit 28a-28n, 30a-30n, and 32a-32n occurred or took place in the event the vehicle 11 departs from the detected geographic location. Such a feature may serve as an indicator that the driver had forgotten to close a garage door or perform some other predetermined operation via the control unit 28a-28n, 30a-30n, and 32a-32n.

The vehicle controller 12 may disallow or prevent the RF transceiver 16 from transmitting certain frequencies or certain power levels based on the geographic location by taking into account the particular county that the control unit 28a-28n is located within. For example, some European countries may not allow the transmission of 315 MHZ. Japan/Korea generally requires the transmission of 433 MHZ at reduced power levels. Additional columns may be added to the LUT to designate countries, regulatory frequencies and protocols, and regulatory power levels that are allowed such that the vehicle controller 12 instructs the RF transceiver 16 to transmit the RF signal at the regulatory frequency and power level based on the county identified by the GPS receiver 18. Such capability may reduce complexity and ensure regulatory compliance.

The vehicle controller 12 may also disallow or prevent the RF transceiver 16 from transmitting RF signals at the corresponding protocol in response to detecting that the vehicle is not at a geographic location this is stored in the LUT. Generally, approximately 50% of garage door opening systems utilize a rolling code. The rest are fixed codes. With the fixed code, a valet or service person can use RF signals generated by the RF transceiver 16 to teach a portable RF transmitter which can then be used at your home to gain unauthorized entry. To eliminate such a concern, the vehicle controller 12 may not allow the RF transceiver 16 not to transmit RF data in the event the vehicle is not at a saved geographic location.

While FIG. 1 generally illustrates that the vehicle interface display 14 and the GPS receiver 18 are separate from one another, it is generally contemplated that the vehicle interface display 14 and GPS receiver 18 may be integrated with each other to form a single controller. In such a case, the integrated vehicle interface display 14 and GPS/NAV controller 18 may facilitate touch screen selection and/or audible interplay between the integrated device 14 and 18 and the occupant to allow the occupant to make the appropriate selection with the desired control unit 28a-28n, 30a-30n, and 32a-32n upon the GPS controller detecting a corresponding geographic location or place 34. It is also contemplated that the vehicle controller 12 and the RF transceiver 16 may be integrated into a stand alone unit.

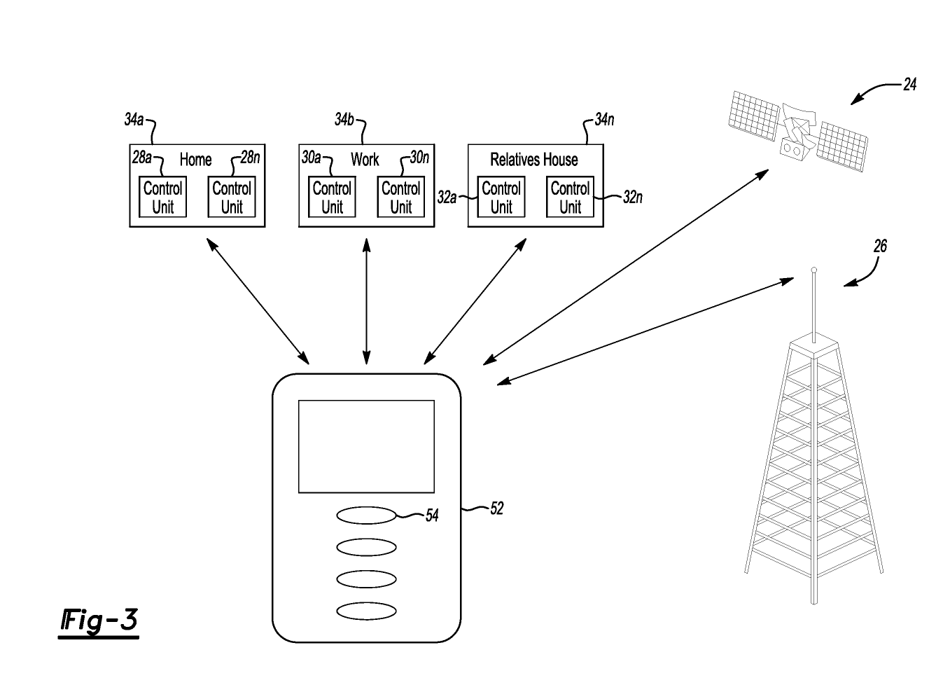

Referring now to FIG. 3, a vehicle system 50 in accordance to another embodiment of the present invention is shown. A portable device 52 is shown and is RF coupled to the control units 28a-28n, 30a-30n, and 32a-32n. The portable device 52 is generally configured to be a hand-held device and integrates the functionality of the vehicle controller 12, the vehicle interface display 14, the transceiver 16 and the GPS receiver 18 as described in connection with FIGS. 1 and 2. The device 52 includes at least one switch 54 for allowing the user to control a particular control unit 28a-28n, 30a-30n, and 32a-32n in response to the device 52 detecting that the user is positioned about the proximity of a particular geographic location or place 34. The programming of the various factory transmitters to the portable GDO device 52 may be implemented in the manner described in connection with FIG. 1.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A vehicle system for controlling at least one radio frequency (RF) receiver/control unit that is positioned exterior to a vehicle at a first location to perform a predetermined operation, the system comprising:
a global positioning satellite (GPS) receiver configured to generate a geographic location signal indicative of the first location of the at least one RF receiver/control unit;
a vehicle controller configured to associate the geographic location signal to an RF control signal; and
a vehicle interface display configured to present at least one menu option for occupant selection to control the operation of the at least one RF receiver/control unit such that the vehicle interface display controls the vehicle controller to transmit the RF control signal to control the at least one RF receiver/control unit to perform the predetermined operation in response to the occupant selecting the at least one menu option.

2. The vehicle system of claim 1 wherein the vehicle interface display is configured to present the at least one menu option in at least one of a visual and an audible format to the occupant.

3. The vehicle system of claim 2 wherein the vehicle interface display is configured to receive occupant selection via at least one of touch switch entry, touch screen entry and audible entry.

4. The vehicle system of claim 1 further comprising an RF transceiver for generating a first RF signal at a predetermined radio frequency and a predetermined protocol to control the RF receiver/control unit to perform the predetermined operation in response to the RF control signal transmitted by the vehicle controller.

5. The vehicle system of claim 4 wherein the GPS receiver, the vehicle controller, the vehicle interface display, and the RF transceiver are operably coupled together via a multiplexed communication bus.

6. The vehicle system of claim 1 wherein the RF-based control signal comprises frequencies in the range of 230 MHz to 950 Mhz.

7. The vehicle system of claim 1 wherein the predetermined operation comprises the operation of at least one of opening/closing a garage door, opening/closing one or more gates at a residential or commercial establishment, activating/deactivating lights at a residential or commercial establishment, activating/deactivating a coffee maker apparatus activating/deactivating a home alarm system and arming/locking at least one vehicle positioned about the first location.

8. The vehicle system of claim 1 wherein the vehicle controller includes a look up table (LUT) for associating the geographic location signal to the RF control signal and the RF control signal includes saved RF data, saved protocol data, saved power level data and a unique ID code for each RF receiver/control unit.

9. The vehicle system of claim 1 wherein the geographic location signal comprises one or more of elevational, longitudinal and latitudinal information with respect to the first location of the at least one RF receiver/control unit.

10. A method for controlling at least one radio frequency (RF) receiver/control unit that is positioned exterior to a vehicle at a first location to perform a predetermined operation, the method comprising:
generating a geographic location signal indicative of the first location of the at least one RF receiver/control unit;
associating the geographic location signal to an RF control signal;
presenting at least one menu option for occupant selection via a interface display; and
controlling the operation of the at least one RF receiver/control unit with the RF control signal in response to the occupant selecting the at least one menu option.

11. The method of claim 10 wherein presenting the at least one menu option for occupant selection further comprises presenting the at least one menu option in at least one of a visual and an audible format to the occupant.

12. The method of claim 11 further comprising receiving occupant selection with the interface display via at least one of touch switch entry, touch screen entry and audible entry.

13. The method of claim 10 wherein performing the predetermined operation further comprises at least one of:
performing the operation of opening/closing a garage door;
performing the operation of opening/closing one or more gates at a residential or commercial establishment;
performing the operation of activating/deactivating lights at a residential or commercial establishment;
performing the operation of activating/deactivating a coffee maker apparatus;
performing the operation of activating/deactivating a home alarm system; and
performing the operation of arming/locking at least one vehicle positioned about the first location.

14. The method of claim 10 wherein presenting the at least one menu option for occupant selection further comprises presenting the at least one menu option in at least one of a visual and an audible format to the occupant.

15. The method of claim 10 further comprising generating a first RF signal corresponding to a predetermined radio frequency, a predetermined unique ID code, a predetermined protocol, and a predetermined power level to control the at least one RF receiver/control unit to perform the predetermined operation in response to the RF control signal.

16. The method of claim 15 further comprising transmitting the first RF signal at the predetermined radio frequency and the predetermined protocol in compliance with a first country regulation in response to the geographic locating signal indicating that the RF receiver/control unit is located in the first country.

17. The method of claim 15 further comprising preventing the transmission of the first RF signal in the event the geographic location signal is not associated to the RF control signal.

18. A device for controlling first and second radio frequency (RF) receiver/control units at first and second locations to perform first and second predetermined operations, respectively, the system comprising:
a global positioning satellite (GPS) receiver/controller configured to generate a first geographic location signal indicative of the first location of the first RF receiver/control unit and a second geographic location signal indicative of the second location of the second RF receiver/control unit;
a vehicle controller configured to associate the first geographic location signal to a first RF control signal and the second geographic location signal to a second RF control signal; and
a interface display configured to present a first menu option for occupant selection to control the operation of the first RF receiver/control unit and a second menu option for occupant selection to control the operation of the second RF receiver/control unit,
wherein the interface display is further configured to control the vehicle controller to transmit the first RF control signal to control the first RF receiver/control unit to perform the first predetermined operation in response to the occupant selecting the first menu option and the second RF control signal to control the second RF receiver/control unit to perform the second predetermined operation in response to the occupant selecting the second menu option.

19. The device of claim 18 wherein the interface display is further configured to present the first and the second menu options in at least one of a visual and an audible format to the occupant and to receive user selection via at least one of touch switch entry, touch screen entry and audible entry.

20. The device of claim 18 further comprising an RF transceiver for generating a first RF control signal at a first predetermined radio frequency and at a first predetermined protocol to control the first RF receiver/control unit to perform the first predetermined operation in response to the first RF control signal, and for generating a second RF control signal at a second predetermined radio frequency and at a second predetermined protocol to control the second RF receiver/control unit to perform the second predetermined operation in response to the second RF control signal.
